(19) United States
(12) Patent Application Publication
(10) Pub. No.: US 2015/0048749 A1
(43) Pub. Date: Feb. 19, 2015

(54) ORNAMENTAL LIGHTING SYSTEM

(71) Applicant: INLITEN, L.L.C., Glenview, IL (US)

(72) Inventors: Matthew P. Braasch, Chicago, IL (US); Yingping Chen, Linhai City (CN)

(21) Appl. No.: 14/033,168

(22) Filed: Sep. 20, 2013

(30) Foreign Application Priority Data
Aug. 16, 2013 (CN) 201310357837.7
Aug. 16, 2013 (CN) 201320501688.2

(51) Int. Cl. H05B 37/02

(52) U.S. Cl. CPC H05B 37/02
USPC 315/193; 315/185 R

(57) ABSTRACT

A lighting system includes a first light string configured to receive a first voltage and output continuous illumination, a second light string, a module electrically connected to the second light string, and a controller electrically connected to the module. The controller receives a user input and outputs a control signal based on the user input. The module receives the control signal and selectively controls a second voltage to the second light string according to the control signal.

### FIELD OF THE INVENTION

The present invention relates to ornamental lighting systems, and more particularly to controlling light strings to cause desired lighting effects.

### BACKGROUND OF THE INVENTION

Ornamental lighting systems normally include a plurality of lights combined into a light string. Often times the light string outputs continuous illumination from the plurality of lights.

### SUMMARY OF THE INVENTION

The invention provides, in one aspect, a lighting system. The lighting system includes a first light string configured to receive a first voltage and output continuous illumination, a second light string, a module electrically connected to the second light string, and a controller electrically connected to the module. The controller is configured to receive a user input and output a control signal based on the user input. The module is configured to selectively control a second voltage to the second light string according to the control signal.

The invention provides, in another aspect, a method of controlling a lighting system. The method includes outputting a first voltage to a first light string, receiving a user input, outputting a control signal based on the user input, and selectively controlling a second voltage to a second light string according to the control signal.

Other aspects of the invention will become apparent by consideration of the detailed description and accompanying drawings.

### BRIEF DESCRIPTION OF THE DRAWINGS

FIGS. 1A-1C illustrate different portions of a circuit diagram of a lighting system in accordance with an embodiment of the invention.

FIG. 2 is a flow chart illustrating an operation of the lighting system of FIGS. 1A-1C.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

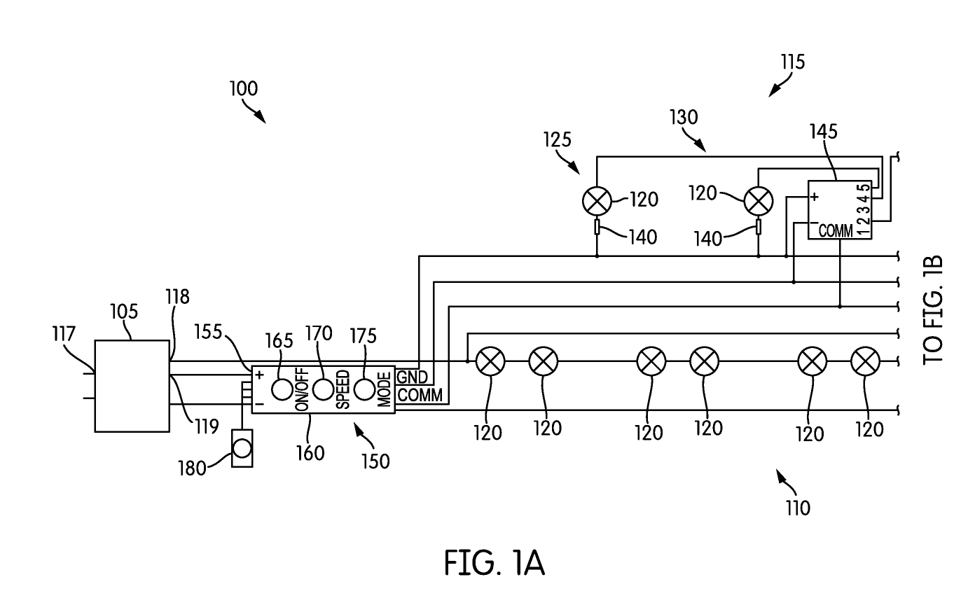

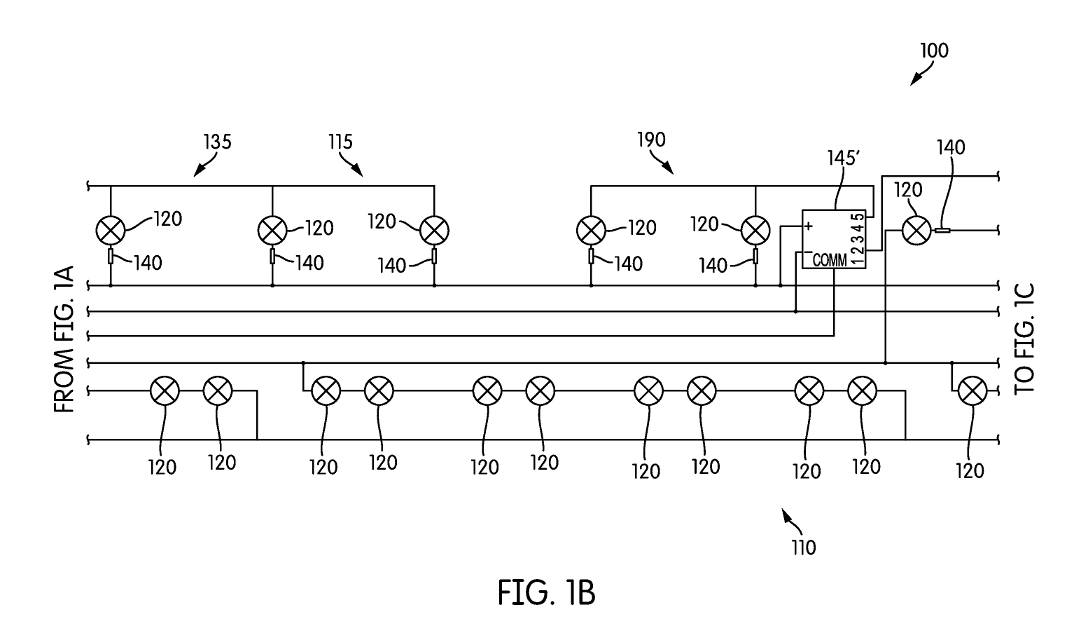

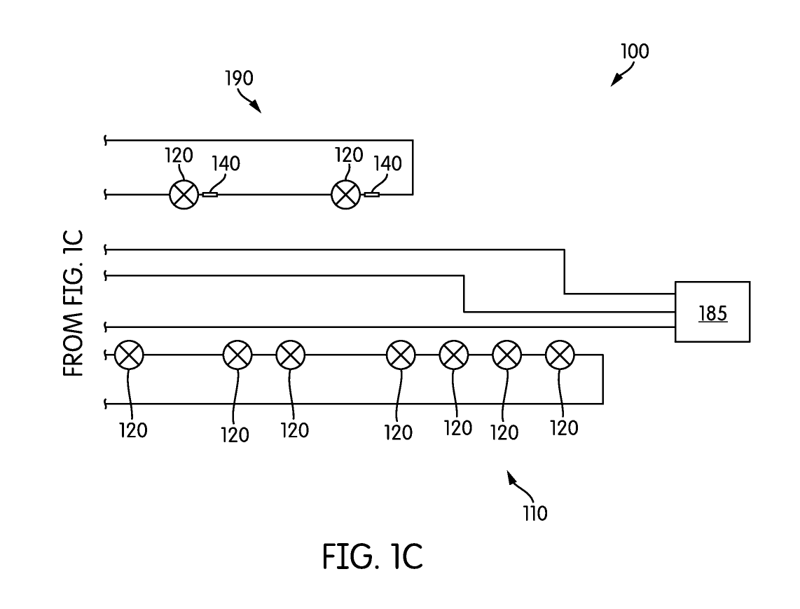

FIGS. 1A-1C illustrate a lighting system 100 including a transformer 105 electrically connected to a first light string 110 and a second light string 115. The transformer 105 receives an input voltage and outputs a transformed voltage. The transformer 105 receives the input voltage at a voltage input 117 and outputs the transformed voltage at a first voltage output 118 and a second voltage output 119. In other embodiments, the transformer 105 includes more or less voltage outputs. The input voltage is nominally between 100 V and 240 V AC and has a frequency of approximately 50-60 Hz. The outputted transformed voltage is a DC voltage having a predetermined voltage (e.g., 0.5 V, 1 V, 2 V, 5 V, etc.). In other embodiments, the input voltage is a DC voltage having a first predetermined voltage and the output voltage is a DC voltage having a second predetermined voltage.

With continued reference to FIGS. 1A-1C, the first light string 110 and the second light string 115 each include lights 120. The lights 120 are light-emitting diodes (LEDs). In other embodiments, however, the lights 120 may be incandescent bulbs. The lights 120 of the second light string 115 are grouped together in a first light group 125 (FIG. 1A), a second light group 130, and a third light group 135 (FIG. 1B). Although not illustrated in FIGS. 1A-1C, the first light string 110 and the second light string 115 are physically intertwined together as a contiguous light string.

The lights 120 of the second light string 115 are electrically connected in series-type configurations with respective resistors 140. The resistors 140 limit the voltage supplied to the lights 120 of the second light string 115 to thereby cause a dimming effect.

The phrase “series-type configuration” as used herein refers to a circuit arrangement where the described elements are arranged, in general, in a sequential fashion such that the output of one element is coupled to the input of another, but the same current may not pass through each element. For example, in a “series-type configuration,” it is possible for additional circuit elements to be connected in parallel with one or more of the elements in the “series-type configuration.” Furthermore, additional circuit elements can be connected at nodes in the series-type configuration such that branches in the circuit are present. Therefore, elements in a series-type configuration do not necessarily form a true “series circuit.”

The lights 120 of the second light string 115 are further electrically connected to a module 145 (FIG. 1A). The module 145 controls the flow of current based on a received signal. In the illustrated embodiment, the module 145 is a switching module containing one or more switches. In some embodiments, the switches are power switches such as, but not limited to, transistors (e.g., FETs, MOSFETs, JFETs, BJTs, IGBTs, etc.).

With continued reference to FIG. 1A, the transformer 105, the second light string 115, and the module 145 are further electrically and/or communicatively connected to a controller 150. The controller 150 receives a user input and outputs a control signal to, among other things, the module 145 via a communication line, which in the drawings is labeled COMM.

The controller 150 includes a combination of hardware and software that is operable, among other things, to control the operation of the module 145 and supply the second voltage to the second light string 115. The controller 150 includes electrical and electronic components that provide power, operational control, and protection to the components within the controller 150 and the lighting system 100. The controller 150 includes, among other components, a processing unit (e.g., a processor), a memory unit (e.g., a memory), a power input 155, and a user-interface 160. The memory unit may include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit is electrically connected to the memory and executes software instructions that are capable of being stored in the memory unit. The software includes, but is not limited to, firmware, one or more applications, program data, filters, rules, one or more program modules, and other executable instructions. The controller 150 retrieves from the memory and executes, among other things, instructions related to the control processes and methods described herein. In other embodiments, the controller 150 includes additional, fewer, or different components.

With continued reference to FIG. 1A, the user-interface 160 is operably coupled to and located proximate to the controller 150. The user-interface 160 receives the user input from a user or operator, and forwards the user input to the controller 150. The user input can influence whether or not the lights 120 in the second light string 115 are continuously illuminated or selectively illuminated or “blink,” the frequency at which the lights 120 in the second light string 115 blink (and whether the frequency is fixed or variable), or the sequence in which the lights 120 within the second light string 115 blink. The user-interface 160 includes a plurality of digital and/or analog user input devices. In the illustrated embodiment, the user-interface 160 includes a power button 165, a speed button 170, and a mode button 175, the function of each of which is described in detail below. In some embodiments, the power button 165, the speed button 170, and the mode button 175 are push buttons.

With continued reference to FIG. 1A, the lighting system 100 further includes a remote user-interface 180 that may be located remotely from the controller 150. The remote user-interface 180 may alternatively receive the user input from the user or operator, and may include a power button, a speed button, and a mode button like those on the controller 150. In some embodiments, the remote user-interface 180 is electrically wired to the controller 150. In other embodiments, the remote user-interface 180 is wirelessly connected to the controller 150.

With reference to FIG. 1C, the lighting system 100 further includes an end connector 185. The end connector 185 is electrically connected to the transformer 105 and the controller 150. The end connector 185 couples the lighting system 100 to a secondary device and outputs voltage and/or the control signal to the secondary device. In some embodiments, the secondary device is at least one of a second lighting system like that shown in FIGS. 1A-1C, a fourth light string, and an individual light.

In some embodiments, such as the embodiment illustrated in FIGS. 1A-1C, the lighting system 100 further includes a third light string 190 and a second module 145′ (FIG. 1B). In such an embodiment, the third light string 190 is substantially similar to the second light string 115, and the second module 145′ is substantially similar to the module 145.

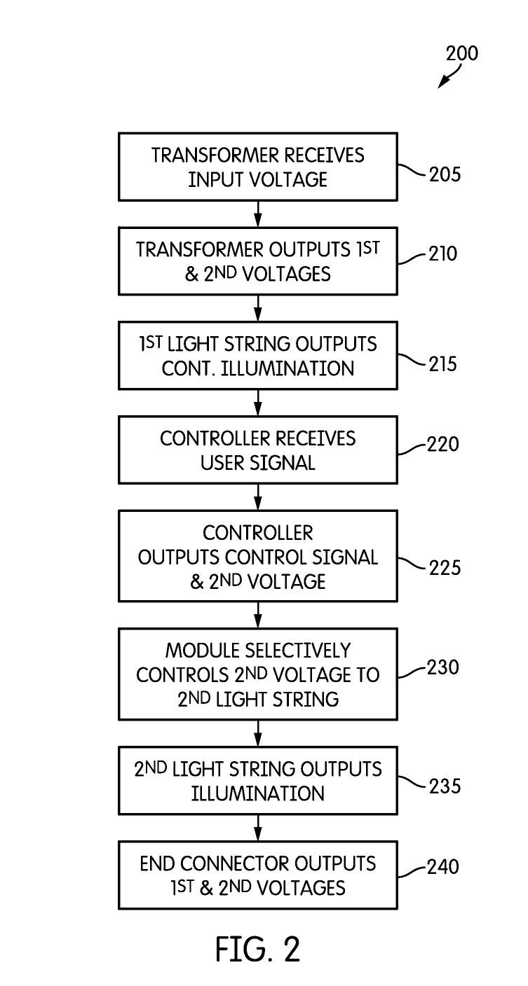

FIG. 2 illustrates an operational flow chart 200 of the lighting system 100. Beginning with Step 205, the transformer 105 receives an input voltage at the voltage input 117 and transforms the input voltage to a first voltage (i.e., a voltage output from the first voltage output 118) and a second voltage (i.e., a voltage output from the second voltage output 119). In some embodiments, the first voltage and second voltage are approximately equal. In other embodiments, the first voltage and second voltage are unequal.

In Step 210, the transformer 105 outputs the first voltage, from the first voltage output 118, to the end connector 185 and the lights 120 of the first light string 110, and outputs the second voltage, from the second voltage output 119, to the controller 150. In other embodiments, the transformer 105 outputs the first voltage and the second voltage to the end connector 185 and the controller 105. In such an embodiment, the controller 105 outputs the first voltage to the lights 120 of the first light string 110. The lights 120 of the first light string 110 output continuous illumination in response to receiving the first voltage (Step 215).

In Step 220, the controller 150 receives a user input via the user-interface 160 or remote user-interface 180. The user input is provided by a user depressing one of the power button 165 (e.g., to turn on or off the system 100), the speed button 170, and/or the mode button 175. By depressing the speed button 170 one or more times, different blinking frequencies of the lights 120 in the second light string 115 and the third light string 190 may be selected. Likewise, by depressing the mode button 175 one or more times, different illumination sequences of the lights 120 in the light strings 115, 190 may be selected. The controller 150 outputs the second voltage to the end connector 185, the module 145, and the second module 145′, and further outputs a control signal through the communication line COMM, based on the received user input, to the module 145 and the second module 145′ (Step 225).

In Step 230, the module 145 selectively controls the second voltage to the lights 120 of the first light group 125, the second light group 130, and the second light group 135 of the second light string 115 according to the received control signal in order to create different lighting effects with the second light string 115. As described above, such lighting effects include continuously illuminating or selectively illuminating or “blinking” the lights 120 in any of the groups 125, 130, 135, making fixed or variable the frequency at which the lights 120 in the second light string 115 blink, or changing the sequence in which the lights 120 within the second light string 115 blink. Such lighting effects give the appearance that the lights 120 in the second light string 115 are “twinkling ” The module 145 selectively controls the second voltage to the lights 120 by selectively connecting the first light group 125, the second light group 130, and the third light group 135 to a common ground GND, thus allowing current to selectively flow through the lights 120 of the light groups 125, 130, 135. In some embodiments, the module 145 selectively controls the second voltage individually to the different groups 125, 130, 135 of the second light string 115. For example, the lights 120 of the first light group 125 may receive the second voltage while the lights 120 of the second group 130 and the lights 120 of the third group 315 do not receive the second voltage.

Also in Step 230, the module 145′ selectively controls the second voltage to the lights 120 of the third light string 190 according to the received control signal in a substantially similar manner as module 145 described above, or in a different manner to yield different sequences and/or frequencies of illumination to thereby provide a different “twinkling” effect as the second light string 115. The lights 120 of the second light string 115 and the lights 120 third light string 190 illuminate upon receiving the second voltage (Step 235).

In Step 240, the end connector 185 outputs the first voltage and the second voltage to a secondary device, such as at least one of a second lighting system like that shown in FIGS. 1A-1C, a fourth light string, and an individual light. In some embodiments, the end connector 185 further outputs the control signal, along with the first voltage and the second voltage, to the secondary device.

Various features and advantages of the invention are set forth in the following claims.

What is claimed is:

1. A lighting system comprising:
a first light string configured to receive a first voltage and output continuous illumination;
a second light string;
a module electrically connected to the second light string; and
a controller electrically connected to the module, the controller configured to receive a user input, and
output a control signal to the module based on the user input; and
wherein the module is configured to selectively control a second voltage to the second light string based upon the control signal.

2. The lighting system of claim 1, wherein the control signal selectively causes the second light string to exhibit a lighting effect.

3. The lighting system of claim 2, wherein the second light string includes a plurality of lights, and wherein the lighting effect involves at least one of continuously illuminating the lights of the second light string, causing the lights of the second light string to blink at a fixed or a variable frequency, and providing at least one sequence in which the lights of the second light string blink.

4. The lighting system of claim 1, further comprising a third light string.

5. The lighting system of claim 4, further comprising a second module electrically connected to the controller and the third light string, wherein the second module is configured to selectively control the second voltage to the third light string based upon the control signal.

6. The lighting system of claim 1, further comprising a resistor connected in a series-type connection with the second light string, wherein the resistor is configured to limit the second voltage supplied to the second light string.

7. The lighting system of claim 1, wherein the controller includes a user-interface.

8. The lighting system of claim 7, wherein the user-interface is remote from the controller.

9. The lighting system of claim 8, wherein the user-interface is wirelessly connected to the controller.

10. The lighting system of claim 1, further comprising an end connector operable to output the first voltage and the second voltage.

11. The lighting system of claim 1, wherein selectively controlling the second voltage to the second light string includes selectively connecting the second light string to a common ground.

12. The lighting system of claim 1, further comprising a transformer, wherein the transformer receives an input voltage and outputs the first voltage and the second voltage.

13. The lighting system of claim 1, wherein the module is a switch

14. A method of controlling a lighting system, the method comprising:
outputting a first voltage to a first light string;
receiving a user input;
outputting a control signal in response to the user input; and
selectively controlling a second voltage to a second light string based upon the control signal.

15. The method of claim 14, further comprising causing the second light string to exhibit a lighting effect based upon the control signal.

16. The method of claim 15, wherein the second light string includes a plurality of lights, and wherein the lighting effect involves at least one of continuously illuminating the lights of the second light string, causing the lights of the second light string to blink at a fixed or a variable frequency, and providing at least one sequence in which the lights of the second light string blink.

17. The method of claim 14, further comprising selectively controlling the second voltage to a third light string based upon the control signal.

18. The method of claim 14, further comprising limiting the second voltage to the second light string.

19. The method of claim 14, wherein outputting the first voltage to the first light string results in a continuous illumination of the first light string.

20. The method of claim 14, wherein selectively controlling the second voltage includes selectively connecting the second light string to a common ground.
